(19) United States
(12) Patent Application Publication
(10) Pub. No.: US 2002/0163279 A1
(43) Pub. Date: Nov. 7, 2002

(54) Actuator and method for mounting an actuator

(76) Inventors: Michael Mueller, Rutesheim (DE); Peter Steuer, Karlsruhe (DE); Robert Heitz, Buehlertal (DE); Stefan Kolmorgen, Tiefenbronn (DE)

Correspondence Address: Striker Striker & Stenby, 103 East Neck Road, Huntington, NY, 11743, US

(21) Appl. No.: 09/980,561

(22) PCT Filed: Mar. 17, 2001
(86) PCT No.: PCT/DE01/01029

(51) Int. Cl. H02K 13/00

(52) U.S. Cl. 310/239

(57) ABSTRACT

An actuator in the prior art includes a plug contact, which is disposed on a printed circuit board, and also includes a brush holder, which is not disposed on the printed circuit board but is electrically connected to it. This has the disadvantage of requiring additional electrical connections. In an actuator (1) of the invention, the brush holder (41) is loosely coupled to the printed circuit board (31) and secured to a housing (9), so that electrical connections of the brush holder (41) and printed circuit board (31) are produced simply and without additional means.

### PRIOR ART

The invention is based on an actuator and a method for mounting an actuator as generically defined by the preambles to claims 1 and 10, respectively.

From European Patent Disclosure EP 0 865 148 A1, a commutator motor with a motor operation sensor is known, in which a plug is disposed on a printed circuit board. A brush holder is embodied separately from the printed circuit board.

German Patent Disclosure DE 198 051 85 A1 shows a drive device in which a brush holder is embodied integrally with a plug receptacle. The receptacle is then mounted on a printed circuit board.

From European Patent Disclosure EP 0 474 904 B1, a commutator-gear drive unit is known, in which a brush holder and a plug are disposed separately from one another on a printed circuit board.

These devices have the disadvantage that the production process is very complicated and thus expensive. Moreover, the solid connection of the brush holder and the printed circuit board has the disadvantage that a precise, simultaneous adaptation of tolerances of brush holders with carbon brushes to the commutator and printed circuit board with switch elements, such as Hall elements, which each have different system interfaces, proves to be quite difficult.

Moreover, this solid connection makes a calibration necessary.

### ADVANTAGES OF THE INVENTION

The actuator of the invention and the method of the invention for mounting an actuator, as defined by the bodies of claims 1 and 10, respectively, has the advantage over the prior art that in a simple way, the production process is simplified and the operating reliability is improved, and in addition mechanical stresses are reduced.

By the provisions and method steps recited in the dependent claims 2-9 and 11, respectively, advantageous refinements of and improvements to the actuator defined by claim 1 and the method defined by claim 10 for mounting an actuator are possible.

It is advantageous for the brush holders to be coupled loosely to the printed circuit board for installation in the actuator, because as a result the brush holder aligns itself with the commutator of the electric motor.

It is also advantageous to couple the brush holder loosely to the printed circuit board by means of detent elements, because this simplifies the installation of the brush holder.

Fastening the brush holder to the housing creates the advantage that the brush holder is decoupled from the printed circuit board, and mechanical vibration of the motor is not transmitted to the printed circuit board.

It is also advantageous that electrical components are disposed movably in a receptacle on the brush holder, because as a result their electrical connection lines can be electrically connected to the printed circuit board without mechanical stresses, once the brush holder is mounted in the housing.

For the mounting, it is advantageous that individual parts of the gear housing or of the electronics housing, which comprise at least one upper part and at one least lower part, are integral or are integral with the motor housing, because this reduces the number of parts to be mounted and reduces the effort and expense of production.

The fixation of the printed circuit board in the housing is advantageously done by disposing elastic contact-pressure elements on the lower part of the housing, since as a result the printed circuit board is not secured rigidly to the housing.

In the mounting of the actuator, it is advantageous for the detent hooks between the brush holder and the printed circuit board to be released.

### DRAWING

One exemplary embodiment of the invention is shown in simplified form in the drawing and explained in further detail in the ensuing description.

Shown are

FIG. 1, an actuator in an exploded view;

FIG. 2, a brush holder; and

FIG. 3, a crush holder, a printed circuit board and a housing in cross section.

### DESCRIPTION OF THE EXEMPLARY EMBODIMENT

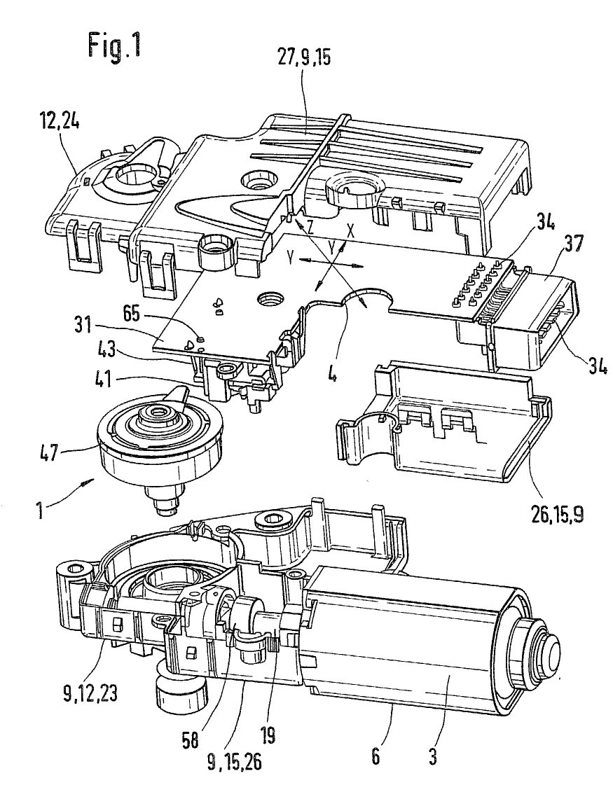

FIG. 1 shows an actuator 1. The actuator 1 has an electric motor 3, which is accommodated in a motor housing 6. Among other elements, the electric motor 3 comprises a stator and a rotor, whose shaft 19 protrudes out of the motor housing 6. The motor housing 6 is connected to a housing 9 into which the shaft 19 protrudes. The housing 9 includes a gear housing 12 and an electronics housing 15. The housing 9 has at least one upper part and at least one lower part. The gear housing 12 correspondingly has at least one upper part 23 and at least one lower part 24. By way of example, the electronics housing 15 likewise has at least one upper part 26 and at least one lower part 27. In this example, the lower part 24 of the gear housing 12 and the lower part 27 of the electronics housing are embodied integrally. The same can be provided accordingly for other individual parts of the housing 9. In addition, at least one part, such as an upper part 26 of the electronics housing and an upper part 23 of the gear housing, can be embodied integrally with the motor housing 6.

Plug contacts 34, which are parts of a plug 37, are connected to a printed circuit board 31. The printed circuit board 31 also supports electrical components of a motor electronics unit 4, the latter not shown in further detail here. A brush holder 41 is coupled to the printed circuit board 31 by means of detent hooks 34. The brush holder 41 is disposed for instance in the region of the electronics housing 15. A gear 47 is also inserted into the gear housing 12. The shaft 19 of the electric motor 3 engages the gear 47.

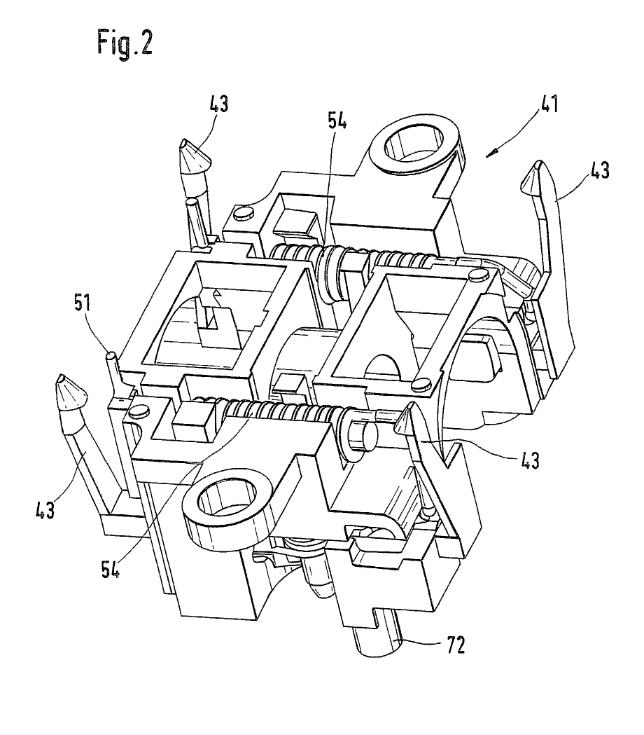

FIG. 2 shows an underside of the brush holder 14, which in the built-in state faces directly toward the printed circuit board 31.

The brush holder 41 in this example has detent hooks 43, for example four of them, with which it is loosely coupled to the printed circuit board 31 by gripping.

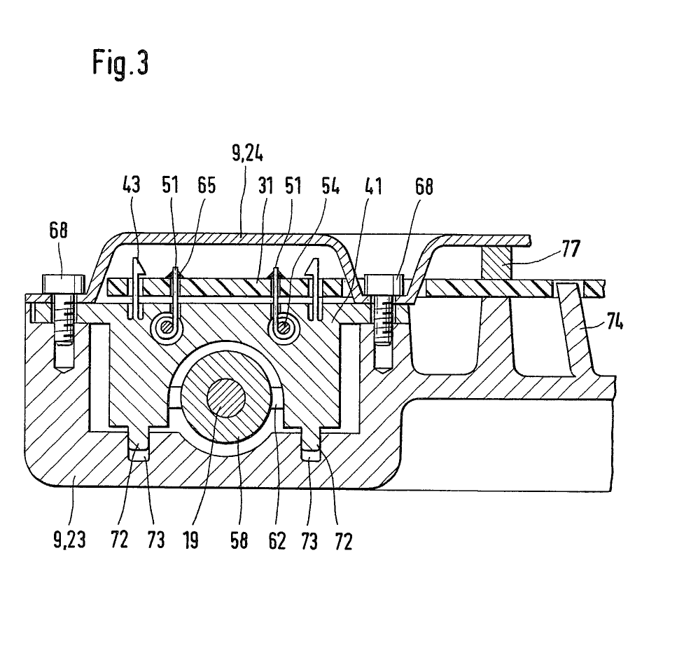

The brush holder 41 also includes brushes 62 (FIG. 3), not shown in further detail here. Also disposed in the brush holder are interference suppression elements 54, in this case for instance electrical choke coils, whose electrical connection lines or wires 51 protrude out of the underside of the brush holder 41. In the built-in state of the brush holder 41 and the printed circuit board 31, these connection lines or wires 51 pass through the printed circuit board 31, for instance, and are soldered to one side of the printed circuit board 31.

FIG. 3 shows the brush holder 41, printed circuit board 31 and housing 9 in cross section. The cross section through the actuator 1 here extends perpendicular to the shaft 19. For the same parts or parts that function the same, the same reference numerals as in the previous drawing figures are used.

A commutator 58 is secured to the shaft 19 and is engaged by brushes 62 for transmitting current. The brushes 62 are disposed in the brush holder 41.

Connection lines or wires 51 of the electrical interference suppression element 54 protrude through the printed circuit board 31, for instance, and are electrically connected to the printed circuit board 31 by means of a soldering point 65. The electrical connection lines or wires 51 furthermore have enough play that they are passed through the printed circuit board 31, for instance, without tension.

A screw 68 connects the upper housing part 23, 26 and the lower housing part 24, 27 to one another and clamps the brush holder 41 between the housing parts. This fastening causes the detent hooks 43 to lift up, so they no longer engage the printed circuit board 31.

The brush holder 41 has fixation pegs 72, which each engage a corresponding indentation 73 in the housing 9. By means of elastic contact-pressure elements 77, which are secured to one part of the housing 9, the printed circuit board 31 is fixed to another part of the housing 9.

The mounting of an actuator 1 will be described below. By way of example, the electric motor 3 is already in its prefabricated state. The upper part 23, 26 of the housing 9 is then secured to the motor housing 6. As a result, the shaft 19 of the electric motor 3 protrudes into the gear housing 12. Next, a gear 47 is built into the housing 9.

After that, the printed circuit board 31, with the brush holder 41 loosely coupled to the printed circuit board 31, for instance by means of detent hooks 43, is introduced into the housing 9.

Guide pegs 72 of the brush holder 41 engage an indentation 73 of the housing 9, as a result of which the brush holder 41 is guided. The brushes 62 of the brush holder 61 grip the commutator 58. This centers the brush holder 41 relative to the commutator 58.

The printed circuit board 31 is likewise aligned, independently of the centering of the brush holder 41, in the housing 9 by means of guide protrusions 74.

After that, the lower part of the gear housing 12 and of the electronics housing 15 is mounted and secured to the upper part by means of screws 68. As a result, the brush holder 41 is clamped between the upper part and the lower part and secured independently of the position of the printed circuit board 31.

The printed circuit board 31 is fixed in the housing 9 by means of elastic contact-pressure elements 77, which are secured to the housing 9.

1. An actuator (1), in particular for an assembly of a motor vehicle,
having a unit comprising an electric motor (3), a gear (47), and a motor electronics unit (4),
having a housing (9), which comprises a gear housing (12) for the gear (47) and an electronics housing (15) for the motor electronics unit (4),
having a motor housing (6) of the electric motor (3), which housing is connected to the housing (9),
having a shaft (19) of the electric motor (3), which shaft protrudes into the gear housing (12),
having a brush holder (41) in the housing (9),
having a printed circuit board (31),
which is disposed in the electronics housing (15),
which is connected to an external connection plug (37),
which is electrically connected to the brush holder (41) and to components of the motor electronics unit (4),
characterized in that
the brush holder (41), for installation in the actuator (1), is loosely coupled to the printed circuit board (31).

2. The actuator of claim 1,
characterized in that
the brush holder (41), after installation in the actuator (1), is secured to the housing (9).

3. The actuator of claim 1 or 2,
characterized in that
the brush holder (41) is disposed in the region of the electronics housing (15).

4. The actuator of one or more of claims 1-3,
characterized in that
the brush holder (41) is loosely coupled to the printed circuit board (31) by detent elements (43).

5. The actuator of one or more of claims 1-4,
characterized in that
electrical components (54) are disposed movably on the brush holder (41) in a receptacle (72), so that their electrical connection lines (51) can be connected electrically to the printed circuit board (31) without mechanical stresses, when the brush holder (41) is mounted in the housing (9).

6. The actuator of claim 1,
characterized in that
the gear housing (12) and electronics housing (15) comprise at least one upper part (23, 26) and at least one lower part (24, 27), and
that at least one lower part (24) of the gear housing (12) and at least one lower part (27) of the electronics housing (15) are integral.

7. The actuator of claim 1 or 6,
characterized in that
at least one upper part (26) of the electronics housing (15) is integral with at least one upper part (23) of the gear housing (12).

8. The actuator of claim 1,
characterized in that
the motor housing (6) and at least one part of the housing (9) are integral.

9. The actuator of claim 1,
characterized in that
the printed circuit board (31) is fixed to the housing (9) by means of elastic contact-pressure elements (37), which are disposed on the lower part of the housing (24, 27).

10. A method for mounting an actuator (1), comprising an electric motor (3) with a motor housing (6) and having a rotor, which has a shaft (19) with a commutator (58), and having a printed circuit board (31), a housing (9), bearings, a brush holder (41) and electrical components (54), in particular of one or more of claims 1-9, having the following method steps:
the motor housing (6) of the electric motor (3) is connected to the housing (9), so that part of the shaft (19) with the commutator (58) protrudes into the housing (9);
the brush holder (41) is mounted to the printed circuit board (31) having the motor electronics unit (4) and the connection plug (37) by the provision that the detent hooks (43) of the brush holder (41) snap into place on the printed circuit board (31);
the printed circuit board (31) is introduced into the housing (9);
the printed circuit board (31) is guided in the housing (9) by means of at least one guide peg (72);
the brush holder (41) is guided in the housing (9) by means of at least one guide protrusion (74);
brushes of the brush holder (41) grip the commutator (58) and align the brush holder (41) with the commutator (58);
the brush holder (41) is fixed to the housing (9);
the at least one upper part of the electronics housing (26) and the at least one lower part of the housing (24, 27) are mounted.

11. The method of claim 10,
characterized in that
after the installation of the printed circuit board (31) in the actuator (1), the detent hooks (43) of the brush holder (41) are released from the printed circuit board (31).
